(19) United States
(12) Patent Application Publication
(10) Pub. No.: US 2019/0130269 A1
(43) Pub. Date: May 2, 2019

(54) PIPELINED TENSOR MANIPULATION WITHIN A RECONFIGURABLE FABRIC

(71) Applicant: Wave Computing, Inc., Campbell, CA (US)

(72) Inventor: Christopher John Nicol, Campbell, CA (US)

(21) Appl. No.: 16/208,928

(22) Filed: Dec. 4, 2018

Related U.S. Application Data
(63) Continuation-in-part of application No. 16/170,268, filed on Oct. 25, 2018.
(60) Provisional application No. 62/694,984, filed on Jul. 7, 2018.
(60) Provisional application No. 62/692,993, filed on Jul. 2, 2018.
(60) Provisional application No. 62/679,046, filed on Jun. 1, 2018.
(60) Provisional application No. 62/679,172, filed on Jun. 1, 2018.
(60) Provisional application No. 62/650,425, filed on Mar. 30, 2018.
(60) Provisional application No. 62/650,758, filed on Mar. 30, 2018.
(60) Provisional application No. 62/637,614, filed on Mar. 2, 2018.
(60) Provisional application No. 62/636,309, filed on Feb. 28, 2018.
(60) Provisional application No. 62/611,600, filed on Dec. 29, 2017.
(60) Provisional application No. 62/611,588, filed on Dec. 29, 2017.
(60) Provisional application No. 62/594,563, filed on Dec. 5, 2017.
(60) Provisional application No. 62/594,582, filed on Dec. 5, 2017.
(60) Provisional application No. 62/579,616, filed on Oct. 31, 2017.
(60) Provisional application No. 62/577,902, filed on Oct. 27, 2017.
(60) Provisional application No. 62/773,486, filed on Nov. 30, 2018.

(51) Int. Cl. G06N 3/08; G06N 3/04

(52) U.S. Cl. CPC G06N 3/08; G06N 3/04

(57) ABSTRACT

Techniques are disclosed for pipelined tensor manipulation within a reconfigurable fabric. A tensor is obtained for processing on a reconfigurable fabric comprised of a plurality of processing elements. The tensor is applied as input to a pipeline of agents running on the plurality of processing elements. The tensor is sectioned into subsections. A first subsection from the one or more subsections is applied to a first agent in the pipeline of agents. A first result is calculated by the first agent for the first subsection. The first result is output to a second agent in the pipeline of agents. A second result is calculated, by the second agent, based on the first result. A subsection done indication is sent, by the second agent, to the first agent, when the calculating the second result is accomplished. The second result is output to a third agent in the pipeline of agents.

### RELATED APPLICATIONS

This application claims the benefit of U.S. provisional patent applications “Pipelined Tensor Manipulation Within a Reconfigurable Fabric” Ser. No. 62/594,563, filed Dec. 5, 2017, “Tensor Manipulation Within a Reconfigurable Fabric Using Pointers” Ser. No. 62/594,582, filed Dec. 5, 2017, “Dynamic Reconfiguration With Partially Resident Agents” Ser. No. 62/611,588, filed Dec. 29, 2017, “Multithreaded Dataflow Processing Within a Reconfigurable Fabric” Ser. No. 62/611,600, filed Dec. 29, 2017, “Matrix Computation Within a Reconfigurable Processor Fabric” Ser. No. 62/636,309, filed Feb. 28, 2018, “Dynamic Reconfiguration Using Data Transfer Control” Ser. No. 62/637,614, filed Mar. 2, 2018, “Data Flow Graph Computation for Machine Learning” Ser. No. 62/650,758, filed Mar. 30, 2018, “Checkpointing Data Flow Graph Computation for Machine Learning” Ser. No. 62/650,425, filed Mar. 30, 2018, “Data Flow Graph Node Update for Machine Learning” Ser. No. 62/679,046, filed Jun. 1, 2018, “Dataflow Graph Node Parallel Update for Machine Learning” Ser. No. 62/679,172, filed Jun. 1, 2018, “Neural Network Output Layer for Machine Learning” Ser. No. 62/692,993, filed Jul. 2, 2018, “Data Flow Graph Computation Using Exceptions” Ser. No. 62/694,984, filed Jul. 7, 2018, and “Reconfigurable Fabric Configuration Using Spatial and Temporal Routing” Ser. No. 62/773,486, filed Nov. 30, 2018.

This application is also a continuation-in-part of U.S. patent application “Tensor Manipulation Within a Neural Network” Ser. No. 16/170,268, filed Oct. 25, 2018, which claims the benefit of U.S. provisional patent applications “Tensor Manipulation Within a Neural Network” Ser. No. 62/577,902, filed Oct. 27, 2017, “Tensor Radix Point Calculation in a Neural Network” Ser. No. 62/579,616, filed Oct. 31, 2017, “Pipelined Tensor Manipulation Within a Reconfigurable Fabric” Ser. No. 62/594,563, filed Dec. 5, 2017, “Tensor Manipulation Within a Reconfigurable Fabric Using Pointers” Ser. No. 62/594,582, filed Dec. 5, 2017, “Dynamic Reconfiguration With Partially Resident Agents” Ser. No. 62/611,588, filed Dec. 29, 2017, “Multithreaded Dataflow Processing Within a Reconfigurable Fabric” Ser. No. 62/611,600, filed Dec. 29, 2017, “Matrix Computation Within a Reconfigurable Processor Fabric” Ser. No. 62/636,309, filed Feb. 28, 2018, “Dynamic Reconfiguration Using Data Transfer Control” Ser. No. 62/637,614, filed Mar. 2, 2018, “Data Flow Graph Computation for Machine Learning” Ser. No. 62/650,758, filed Mar. 30, 2018, “Checkpointing Data Flow Graph Computation for Machine Learning” Ser. No. 62/650,425, filed Mar. 30, 2018, “Data Flow Graph Node Update for Machine Learning” Ser. No. 62/679,046, filed Jun. 1, 2018, “Dataflow Graph Node Parallel Update for Machine Learning” Ser. No. 62/679,172, filed Jun. 1, 2018, “Neural Network Output Layer for Machine Learning” Ser. No. 62/692,993, filed Jul. 2, 2018, and “Data Flow Graph Computation Using Exceptions” Ser. No. 62/694,984, filed Jul. 7, 2018.

Each of the foregoing applications is hereby incorporated by reference in its entirety.

### FIELD OF ART

This application relates generally to tensor manipulation and more particularly to pipelined tensor manipulation within a reconfigurable fabric.

### BACKGROUND

Data is routinely collected by governments, businesses, and researchers, for purposes such as surveillance, tracking, and learning, to name only a few. One result of these data collection efforts is datasets that continuously expand. These datasets, which are often referred to as “big data”, pose significant data processing challenges due in no small part to the sheer volume of data to be processed. While the data processing challenges are significant, the various entities that collect the data are highly motivated to both perform the data analysis and complete a variety of tasks which are based on the data. The tasks typically include learning, marketing, and predicting, among many others. Another data processing challenge includes the computers, computer chips, and other hardware used to perform the data processing. Conventional architectures, processors, and techniques cannot process and analyze the “big data” datasets for the simple reason that the analysis overwhelms the computational capabilities of the conventional systems and approaches. In addition to data access, analysis, capture, maintenance, storage, transmission, visualization, and so on, the data volume can quickly overwhelm the capabilities of the traditional systems. If there were no ability to process the data in a timely fashion, there would be little or no value to the data. Instead, new processing hardware such as advanced computer chips, and software such as algorithms, heuristics, techniques, and so on, are required.

The entities that possess or have access to the datasets are eager to perform a variety of analysis tasks on the data contained in the datasets. Common analysis purposes include: business analysis; complex science and engineering simulations; crime detection and prevention; disease detection, tracking, and control; meteorology; to name only a few. Advanced data analysis techniques such as predictive analytics are applicable because they can be used for extracting value from the datasets for business and other purposes. Other uses for the datasets include machine learning and deep learning.

Data processing performance, particularly as the processing relates to hardware, can be measured based on one or more metrics. The metrics can include high throughput such as data throughput, fast processing response time, low utilization of computational resources, and so on. Performance can also be based on other criteria such as high data bandwidth, high hardware availability, and efficient data storage and transfer, among others. System, hardware, and software design techniques have been developed to address these and other design issues and are used while a data processing technique is being developed. “Performance engineering” is an approach used to design a system which effectively and efficiently meets system design requirements and specifications. This approach can be used to examine design tradeoffs during the system design of hardware and software. The design tradeoffs typically include determining which performance requirements can be met by various architectures and at what cost. The principal objective is to meet the design performance requirements while maintaining or minimally impacting other system performance measures. When done properly, the design result can be a high-performance design that minimizes the use of computational resources.

### SUMMARY

Reconfigurable fabrics can be arranged in a variety of topologies. These topologies are well suited to many applications including data processing, digital signal processing (DSP), neural networks such as convolutional neural networks (CNN) and deep neural networks (DNN), and so on, where the data can include specific types of data, large quantities of unstructured data, and the like. The reconfigurable fabrics can be coded or scheduled to realize these and other processing techniques. Reconfigurable fabrics can be comprised of processing elements, switching elements, and/or memory elements. The reconfigurable fabric topology can be arranged to form a dataflow processor. A dataflow processor is a fundamentally different approach than a Von Neumann or other traditional control flow computational architectures, which are not well suited to highly data-intensive processing requirements.

Although designers and architects continue to construct faster processors, improved custom integrated circuits or chips, more capable application specific integrated circuits (ASIC), and so on, the new designs are architectures fail to meet the data processing demands because these architectures are not specifically designed for the processing of vast amounts of data. An alternative architecture to the control flow architectures is based on dataflow. In a dataflow architecture, the execution of instructions, functions, subroutines, etc., is based on the presence or absence of data. This latter approach, that of a dataflow architecture, is better suited to handling the large amounts of unstructured data that is processed as part of the machine learning and deep learning applications. Further, the reconfigurable fabric can be scheduled to represent a variety of computer architectures within the dataflow architecture that can perform computations more efficiently. One such architecture is a pipelined dataflow architecture, where processing elements such as data processing elements are coupled in series. Like Adam Smith's pin factory or a modern assembly line, data processing tasks can be divided among the processors in the pipeline. When the pipeline is full, and each processor is handling data in a given period of time, the overall data processing objective becomes more efficient while the requirements of the individual processors is reduced.

Pipelined tensor manipulation is realized using a reconfigurable fabric. The reconfigurable fabric includes processing elements, switching elements, storage elements, communications capabilities, and so on. Embodiments include a processor-implemented method for tensor manipulation comprising: obtaining a tensor for processing on a reconfigurable fabric comprised of a plurality of processing elements; applying the tensor as input to a pipeline of agents running on the plurality of processing elements; sectioning the tensor into one or more subsections; applying a first subsection from the one or more subsections to a first agent in the pipeline of agents; calculating a first result by the first agent for the first subsection; and outputting the first result to a second agent in the pipeline of agents. Embodiments further comprise calculating a second result, by the second agent, based on the first result. Other embodiments further comprise outputting the second result to a third agent in the pipeline of agents.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for pipelined tensor manipulation within a reconfigurable fabric.

FIG. 2 is a flow diagram for storage in the context of agents.

FIG. 3 is a block diagram showing agent and storage structure.

FIG. 4 illustrates tensor processing and block processing flow.

FIG. 5 is an example showing an agent pipeline.

FIG. 6 illustrates a deep learning block diagram.

FIG. 7 shows a cluster for coarse-grained reconfigurable processing.

FIG. 8 illustrates a block diagram of a circular buffer.

FIG. 9 illustrates a circular buffer and processing elements.

FIG. 10 is a system diagram for pipelined tensor manipulation within a reconfigurable fabric.

### DETAILED DESCRIPTION

Techniques are disclosed for pipelined tensor manipulation within a reconfigurable fabric. A pipeline includes a plurality of processors, where the processors can be coded to perform various computations. In addition, the pipeline can include storage elements, switching elements, control elements, and so on, which may be included to operate the pipeline, to support the pipeline, to configure the pipeline, and so on. The processors or processing elements of the pipeline can be coupled in series. By using a series configuration, the output of a processing element or stage of the pipeline can be directed to the input of the next processing element of the pipeline. In some embodiments, there can be a plurality of pipelines, where the pipelines can operate in parallel, independently, etc. The pipelines can branch, fork, join, and so on. When the pipeline is filled, the processing elements of the pipeline can operate in parallel. When the processes that are executed by the processing elements are asynchronous, buffers can be placed between the processing elements of the pipeline to support retiming techniques.

A reconfigurable fabric can include elements, where the elements can be configured to perform a variety of computational tasks. The elements can be configured as processing elements, storage elements, switching elements, and so on. The reconfigurable fabric can include clusters or quads of elements, where the quads can include processing elements, shared storage elements, controls, and the like. An element of the reconfigurable fabric can be controlled by providing code, where the code configures the element as a processing element, switching element, storage element, etc. Code can also be provided to the reconfigurable fabric so that the reconfigurable fabric can perform various computational tasks such as tensor manipulation. To control elements of the reconfigurable fabric, one or more rotating circular buffers can be used. With instructions loaded into the circular buffer, the rotation of the circular buffer ensures that the same series of steps or instructions is repeated for as long and as frequently as required by the processing tasks assigned to the reconfigurable fabric. The one or more rotating circular buffers can be statically scheduled.

Pipelined tensor manipulation is performed within a reconfigurable fabric. A tensor is obtained for processing on a reconfigurable fabric comprised of a plurality of processing elements. The tensor can include a plurality of arrays, a multidimensional matrix, etc. The tensor is applied as input to a pipeline of agents running on the plurality of processing elements. The pipeline of agents can include two or more agents and can include storage elements. The storage elements can be interposed between the agents. Agents are predetermined blocks of code running on a reconfigurable fabric element that transform the element into a functional block for the purpose required of the dataflow processor. The tensor is sectioned into one or more subsections. The subsections can include the entire tensor, a block, a tensor row, a tensor column, and so on. A first subsection from the one or more subsections is applied to a first agent in the pipeline of agents. A first result is calculated by the first agent for the first subsection. The first result can include a tensor, a block, a tensor row, a tensor column, and the like. The first result is output to a second agent in the pipeline of agents. A second result can be calculated, by the second agent, based on the first result. A “subsection done” indication is sent by the second agent to the first agent when the calculating of the second result is accomplished.

Embodiments include a pipelined tensor processing system comprising: a first processor element; and a second processor element coupled reconfigurably to the first processor element to provide a reconfigurable pipeline fabric for tensor processing, wherein a tensor accessed by the fabric is partitionable into one or more subsections for pipelined processing by the first and second processor elements.

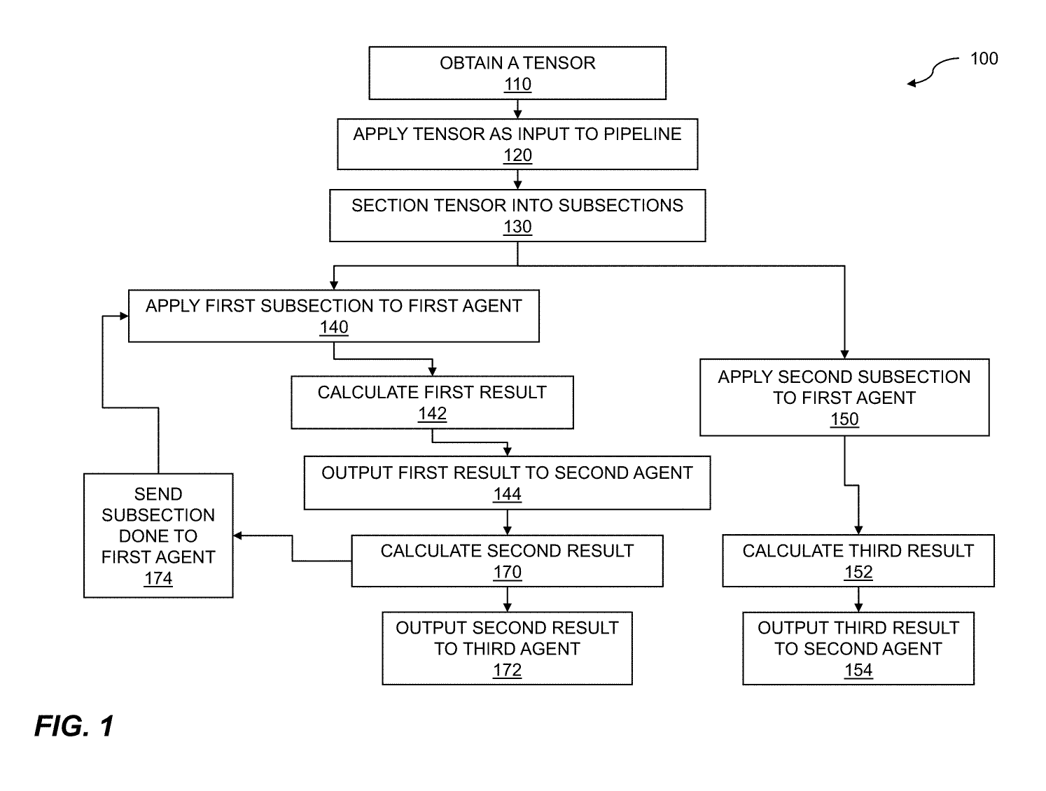

FIG. 1 is a flow diagram for pipelined tensor manipulation within a reconfigurable fabric. The flow 100 includes obtaining a tensor 110 for processing on a reconfigurable fabric comprised of a plurality of processing elements. The tensor can be uploaded by a user, retrieved from a library, downloaded from the Internet, and so on. The tensor can include a plurality of arrays, a multidimensional matrix, etc. The reconfigurable fabric can include elements other than the processing elements such as switching elements, storage elements, and so on. The flow 100 includes applying the tensor as input to a pipeline 120 of agents running on the plurality of processing elements. The pipeline can include storage, where the storage can be interposed between agents. The interposed storage can be shared by two or more agents.

The flow 100 includes sectioning the tensor into one or more subsections 130. The sectioning of the tensor can be performed for various purposes such as enabling parallel computation, supporting pipelined operations, reducing computational complexity, simplifying communications needs, minimizing storage requirements, and so on. The flow 100 includes applying a first subsection from the one or more subsections to a first agent 140 in the pipeline of agents. The applying can include storing the subsection in storage adjacent to the first agent, passing the subsection to the first agent, and so on. In embodiments, the first subsection being applied to the first agent can be the tensor in its entirety. The subsections that can result from the sectioning of the tensor can include other portions of the tensor. In embodiments, the first subsection being applied to the first agent can include a block from the tensor. The tensor can include a plurality of blocks. In other embodiments, the first subsection being applied to the first agent can include a row from the tensor. The tensor can include a plurality of rows. In further embodiments, the first subsection being applied to the first agent can include a column from the tensor.

The flow 100 includes calculating a first result 142 by the first agent for the first subsection. That calculating can be performed by the one or more processing elements to which the first agent has been applied. The flow 100 includes outputting the first result to a second agent 144 in the pipeline of agents. The first result that is output can be stored. In embodiments, storing can include storing the first result in a storage element interposed between the first agent and the second agent. The storage element can include first in first out (FIFO) storage, storage coupled to the reconfigurable fabric, direct memory access (DMA) storage, and so on. The storage can be controlled by a rotating circular buffer, where the rotating circular buffer can be statically scheduled. The flow 100 includes applying a second subsection from the one or more subsections to the first agent 150 in the pipeline of agents. The second subsection can be a block, a tensor row, a tensor column, and so on. The flow 100 includes calculating a third result 152, by the first agent, for the second subsection from the one or more subsections. The calculating can be performed by the one or more processing elements of the reconfigurable fabric to which the second agent has been applied. In embodiments, the calculating the third result, by the first agent, can be performed contemporaneously with the calculating the second result, by the second agent. The flow 100 includes outputting the third result, by the first agent, to the second agent 154. As is the case for other results, the third result can be stored, where the storing can include storing the third result in storage interposed between the first agent and the second agent, storing the third result in storage coupled to the reconfigurable fabric, etc.

The flow 100 further includes calculating a second result 170, by the second agent, based on the first result. The second agent can receive data, such as a tensor, a block, a tensor row, a tensor column, etc., and can calculate a result based on the data. The result can be a tensor, block, tensor row, tensor column, and so on, based on the input data to the second agent. The flow 100 includes outputting the second result to a third agent 172 in the pipeline of agents. The second result can be stored in a storage element, in storage coupled to the reconfigurable fabric, and so on. The form of the second result can depend on the input to the second agent, the type of agent, and so on. In embodiments, the second result can include a tensor block. The tensor block can be one of the subsections of a tensor. The second result can include a tensor row. When the input to an agent is a tensor row, the output from the agent can be a tensor row. Similarly, the second result can include a tensor column. When a tensor column is input into an agent, the output from the agent can include a tensor column. In further embodiments, the second result can include a tensor. The flow 100 further includes sending, by the second agent, a subsection done indication 174, to the first agent, when the calculating the second result is accomplished. A subsection done indication can indicate that the result that was output by the first agent has been consumed for a calculation, so the result can be cleared, overwritten, sent to another agent, and so on. The subsection done indication can be used by the first agent to proceed with calculating a new result based on applying another subsection to the first agent. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

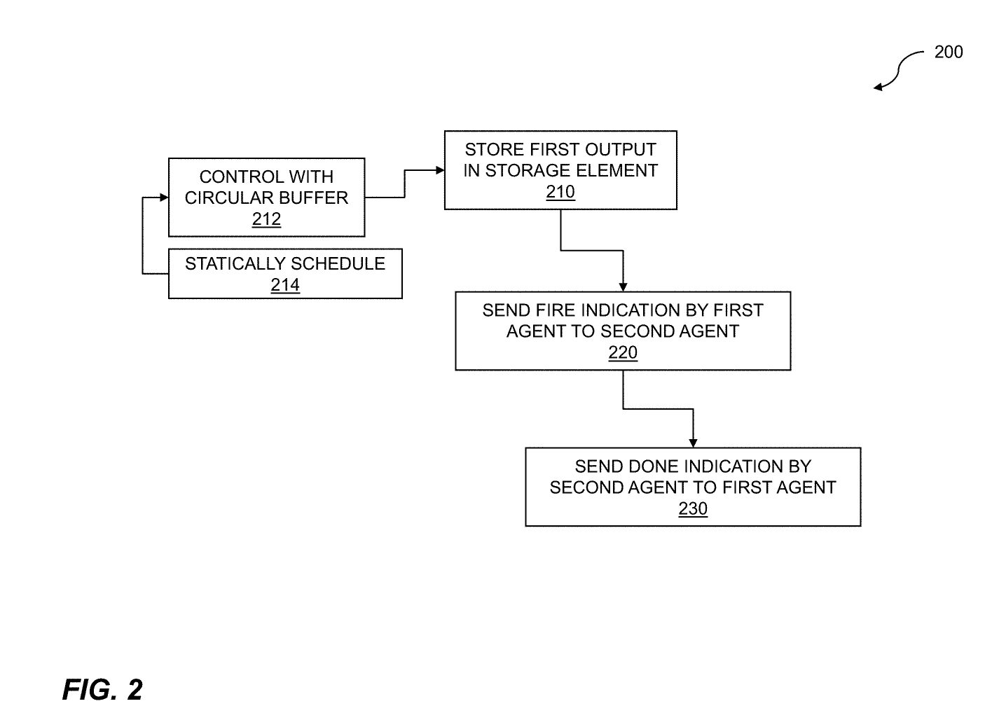

FIG. 2 is a flow diagram for storage in the context of agents. Pipelined tensor manipulation can be performed within a reconfigurable fabric. The reconfigurable fabric can include elements, where the elements can include processing elements, switching elements, storage elements, and so on. The pipelined tensor manipulation can include using a pipeline of agents for manipulating the tensor, subsections of the tensor, etc., and storing results and intermediate results of the manipulations. The flow 200 includes storing the first result, or output, in a storage element 210 interposed between the first agent and the second agent. The storage element can be an element of the reconfigurable fabric which has been configured for storage. The storage element can be a special purpose memory embedded within the reconfigurable fabric. In embodiments, the storage element can include first in first out (FIFO) storage. The FIFO storage can be used as a buffer, such as a buffer between agents. In embodiments, the storing can further include storing the first result in a storage element coupled to the reconfigurable fabric. The storage element coupled to the reconfigurable fabric can be an “off-chip” memory. In embodiments, the storing can include direct memory access (DMA). The storage element can be controlled with a rotating circular buffer 212. The rotating circular buffer can be an element within the reconfigurable fabric. In embodiments, the rotating circular buffer is statically scheduled 214.

The flow 200 further includes sending a fire indication 220 by the first agent, to the second agent signifying that the first result has been written to the storage element. The fire indication can include a control signal, a flag, a semaphore, and so on. The fire indication can indicate that writing of the first result is complete and that the first result is ready to be processed by the second agent. In embodiments, first result can be a block, where a block can be a subsection of a tensor. In other embodiments, the result can be a tensor. The fire indication can include a tensor fire indication, that is, “tfire”, an “initiate” indication, etc. The flow 200 includes sending a done indication 230 by the second agent to the first agent, signifying that the first result has been read from the storage element. The done indication can be used by the first agent to proceed with manipulating a block, a tensor, etc. In embodiments, the done indication can include a tensor done indication, or “tdone” indication. Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

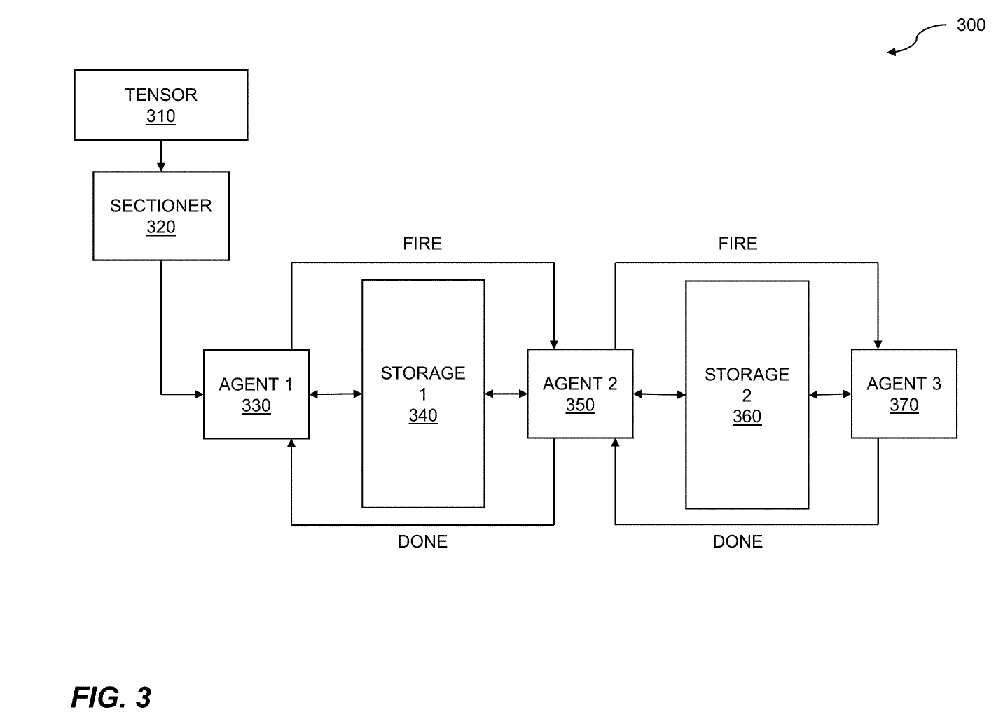

FIG. 3 is a block diagram showing agent and storage structure. The processing of a tensor can be pipelined by sectioning the tensor and applying the subsections of the tensor to a pipeline of agents which perform the processing. The pipelined tensor manipulation can be performed within a reconfigurable fabric. A reconfigurable fabric can include elements, where the elements can include processing elements, switching elements, storage elements, and the like. The elements can be arranged in quads, where processing elements can be grouped with storage elements. The storage elements can be used for storing tensors, blocks, results, intermediate results, etc. In embodiments, the storing of a result can include storing the first result in a storage element interposed between the first agent and the second agent.

The flow 300 shows a block diagram of a structure for pipelined tensor manipulation within a reconfigurable fabric. A tensor 310 can be obtained for processing on a reconfigurable fabric. The tensor can be uploaded by a user, obtained from local or remote storage, downloaded from the Internet, and so on. The tensor can be sectioned into one or more subsections using a “sectioner” 320. A subsection can include a portion of the tensor, the tensor in its entirety, and so on. The first subsection from the one or more subsections of the tensor is applied to the first agent, agent 1 330, of a pipeline of agents. The first agent calculates a result and stores the first result into storage 1 340. Agent 1 sends a fire signal to the second agent in the pipeline, agent 2 350, to indicate that data is ready to be processed by agent 2. Agent 2 sends a done signal back to agent 1 when agent 2 has read data from storage 1. The pipelined processing continues with agent 1 processing the next subsection, and agent 2 processing its data. The second agent, agent 2, calculates a result and stores the result into storage 2 360. Agent 2 sends a fire signal to the third agent, agent 3 370, to indicate that data is ready to be processed by agent 3. The data to be processed can include the tensor in its entirety, a tensor subsection, a tensor block, etc. Agent 3 sends a done signal back to agent 2 when agent 3 completes reading data from storage 2.

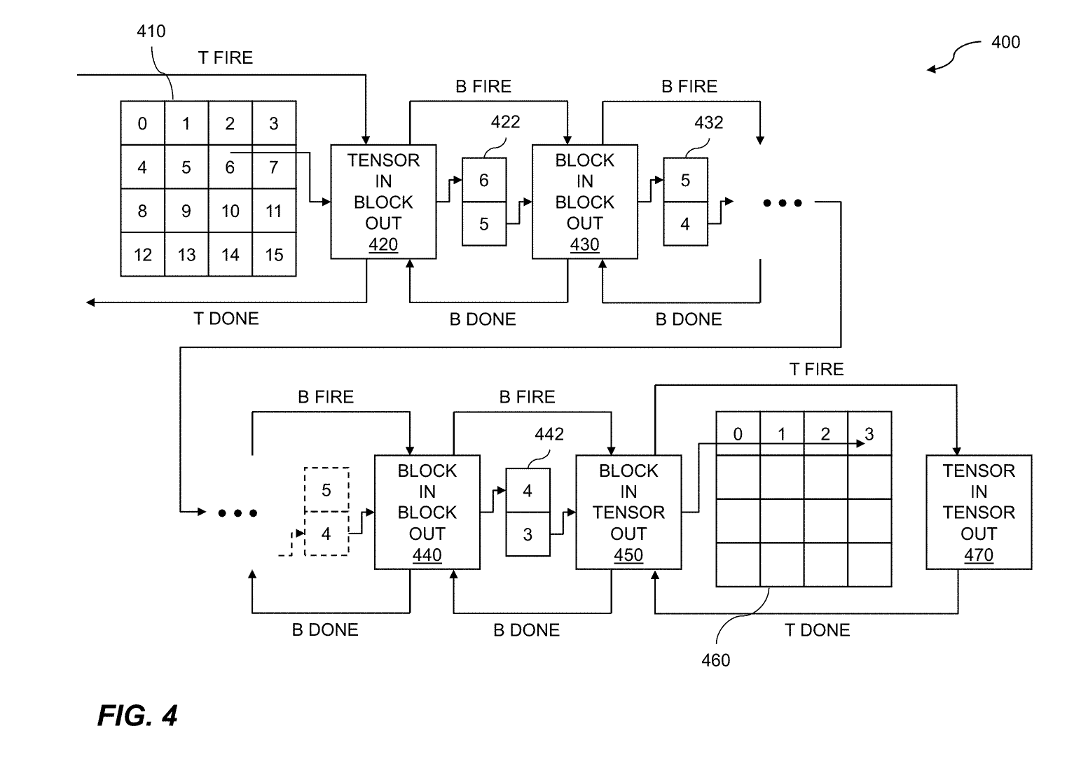

FIG. 4 illustrates tensor processing and block processing flow. A tensor can include one or more blocks. The tensor, the blocks, and so on, can be processed for pipelined tensor manipulation within a reconfigurable fabric. A reconfigurable fabric can include quads of elements. The elements of the reconfigurable fabric can include processing elements, switching elements, storage elements, and so on. An element such as a storage element can be controlled by a rotating circular buffer. In embodiments, the rotating circular buffer can be statically scheduled. Tensors can include one or more blocks. The reconfigurable fabric can be configured to process tensors, tensor blocks, tensors and blocks, etc. The reconfigurable fabric can be configured for pipelined block processing. Agents can be assigned to clusters of quads, where the clusters can include one or more quads. Some of the agents can be configured to process multiple blocks within each tensor. These agents can process each block in chronological order. Multiple agents can be pipelined at a block level when there are sufficient clusters of quads to which the agents can be assigned. Pipelining of the multiple agents can reduce the sizes of intermediate buffers in external memory. Pipelining can further reduce memory bandwidth needs of the reconfigurable fabric, and can enable finer-grained agent-to-agent pipelining of blocks. To support the pipelining, the blocks that are processed by the agents are processed similarly. Agents that process blocks by column can be pipelined, and agents that process blocks by row can be pipelined. Agents that process by column and agents that process by row cannot be pipelined together.

To facilitate the processing of tensors and blocks, control signals can be used. In embodiments, the control signals include fire signals and done signals. A fire signal, tfire, can be a tensor level fire signal used to inform downstream agents that an entire tensor has been written to an output buffer. A fire signal, bfire, can be a block level fire signal used to inform downstream agents that a block has been written to the output buffer. The control signals can also include done signals. A done signal, tdone, can be a tensor level done signal used to inform an upstream agent that an entire tensor has been read from an input buffer. A done signal, bdone, can be a block level done signal used to inform an upstream agent that a block has been read from the input buffer.

The agents discussed above can be used for block processing. The agents can process tensors and tensor blocks. Agents can be classified by the data they process with respect to block processing, namely tensor and block. Four classifications of agents can include tensor in, tensor out; tensor in, block out; block in, tensor out; and block in, block out. A tensor in, tensor out agent can include a “normal” agent that can process entire tensors from input buffers, and can write entire processed tensors at output buffers. This classification of agent can use the tfire and tdone signals to manage tensors at input and output buffers. A tensor in, block out agent can include a transitional agent that can process entire tensors from input buffers, and can transfer data block by block to agents downstream in a pipeline. This classification of agent uses signals tfire and tdone with upstream agents, and signals bfire and bdone with downstream agents. A block in, tensor out agent can include a transitional agent that can process blocks from input buffers using bfire and bdone signals, and tensors at output buffers using tfire and tdone signals with downstream agents. A block in, block out agent can include a pipelined agent that can process blocks at an input and can provide blocks to output buffers. This classification of agent can use signals bfire and bdone for handling blocks through both input and output buffers.

Returning to the figure, FIG. 4 shows tensor processing and block processing flow 400. Agents can switch between tensor processing and block processing. An input tensor 410 is processed by a tensor in, block out agent 420 that produces an output for block 422. The block in, block out agent 430 receives a bfire signal from agent 420, and processes an input from block 422 to produce an output for block 432. Agent 430 sends a bdone signal back to agent 420 so that agent 420 may continue processing. A block in, block out agent 440 receives a bfire signal from agent 430, and processes input from block 432 to produce output for block 442. Agent 440 sends a bdone signal back to agent 430. Agent 440 sends a bfire signal to the block in, tensor out agent 450. Agent 450 processes the input from block 442 to produce a tensor 460. Agent 450 sends a bdone signal back to agent 440, and sends a tfire signal to tensor in, tensor out agent 470. Processing by the pipeline of agents 420, 430, 440, 450, and 470 continues while there is input tensor data to be processed.

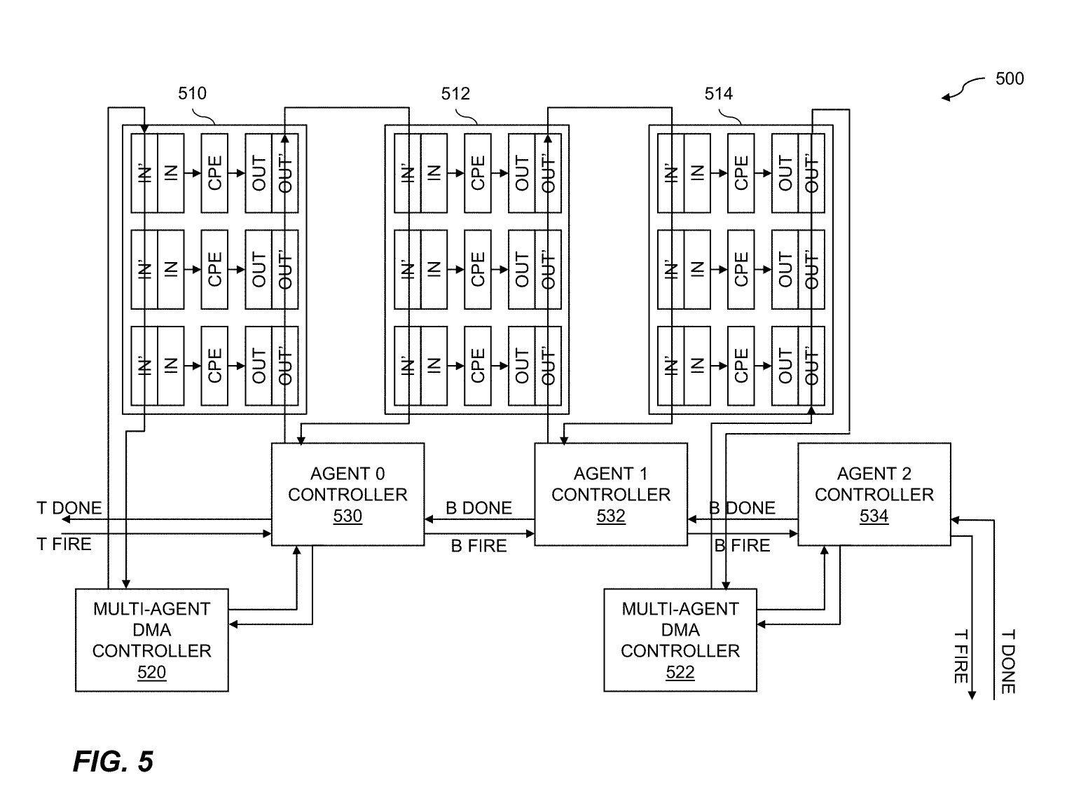

FIG. 5 is an example showing an agent pipeline. An agent pipeline can include one or more agents that can be assigned to one or more clusters of processing elements within a reconfigurable fabric. The agent pipeline can be used for pipelined tensor manipulation within the reconfigurable fabric. An example agent pipeline is shown 500. Data movement through three agents is shown where the data movement includes on-chip block pipelining through a second agent. Each agent can be assigned to one or more clusters of processors within the reconfigurable fabric. The first agent, agent 0 510, can be of type Tensor in, Block out; the second agent, agent 1 512, can be of type Block in, Block out; the third agent, agent 2 514, can be of type Block in, Tensor out; etc. Each agent can have an agent controller associated with it such as agent 0 controller 530, agent 1 controller 532, agent 2 controller 534, and so on.

The transfers of tensors and blocks can include external transfers, internal transfers, and so on. For an external transfer, the first agent 510 and third agent 514 can both read and write tensors to external memory. The external memory can be coupled to a reconfigurable fabric. Reading and writing to the external memory can be accomplished using multi-agent direct memory access (DMA) controllers to manage the transfers. In the example, multi-agent DMA controllers can include multi-agent DMA controller 520, multi-agent DMA controller 522, and so on. For the transfer from external memory to a first kernel, kernel 0, the clusters of processing elements that can be assigned to kernel 0 can be slave writers. For the transfer from a second kernel, kernel 2, to external memory, the clusters of processing elements that can be assigned to kernel 2 can be slave readers. Agent 0 and agent 2 can use control signals, such as tfire and tdone signals, for communicating with upstream and downstream agents respectively.

The transfers of tensors and blocks can include internal transfers. For an internal transfer, a first agent such as agent 0 510 can send a block output to a second agent such as agent 1 512, using a kernel to kernel DMA transfer within the reconfigurable fabric. The first agent controller (agent 0 530) can be the master. The clusters in kernel 0 can be slave readers, and the clusters in kernel 1 can be slave writers. Agent 1 512 can send an output block to agent 2 514 using a kernel to kernel DMA transfer. For this latter case, agent 1 controller 532 can be the master, the clusters in kernel 1 can be slave readers, and the clusters in kernel 2 can be slave writers. Control signals such as bfire and bdone can be used to facilitate the synchronization of the block data transfers between the agents.

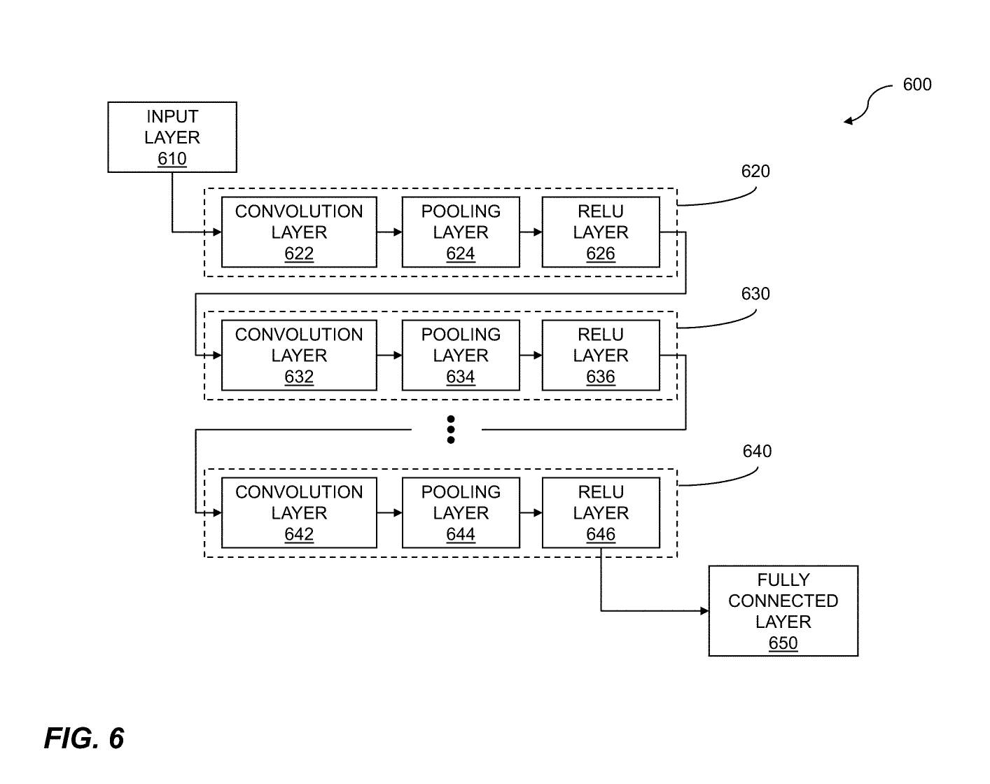

FIG. 6 illustrates a deep learning block diagram. The deep learning block diagram 600 can include a neural network such as a deep neural network (DNN), a convolutional neural network, and so on. The convolutional neural network can be based on layers. The layers of the convolutional network can be implement using a reconfigurable fabric. Pipelined tensor manipulation can be performed within a reconfigurable fabric.

A deep learning block diagram 600 is shown. The block diagram can include various layers, where the layers can include an input layer, hidden layers, a fully connected layer, and so on. In some embodiments, the deep learning block diagram can include a classification layer. The input layer 610 can receive input data, where the input data can include a first collected data group, a second collected data group, a third collected data group, a fourth collected data group, etc. The collecting of the data groups can be performed in a first locality, a second locality, a third locality, a fourth locality, and so on, respectively. The input layer can then perform processing such as partitioning collected data into non-overlapping partitions. The deep learning block diagram 600, which can represent a network such as a convolutional neural network, can contain a plurality of hidden layers. While three hidden layers, hidden layer 620, hidden layer 630, and hidden layer 640 are shown, other numbers of hidden layers may be present. Each hidden layer can include layers that perform various operations, where the various layers can include a convolution layer, a pooling layer, and a rectifier layer such as a rectified linear unit (ReLU) layer. Thus, layer 620 can include convolution layer 622, pooling layer 624, and ReLU layer 626; layer 630 can include convolution layer 632, pooling layer 634, and ReLU layer 636; and layer 640 can include convolution layer 642, pooling layer 644, and ReLU layer 646. The convolution layers 622, 632, and 642 can perform convolution operations; the pooling layers 624, 634, and 644 can perform pooling operations, including max pooling, such as data down-sampling; and the ReLU layers 626, 636, and 646 can perform rectification operations. A convolutional layer can reduce the amount of data feeding into a fully connected layer. The block diagram 600 can include a fully connected layer 650. The fully connected layer can be connected to each data point from the one or more convolutional layers.

Dataflow processors can be implemented within a reconfigurable fabric. Dataflow processors can be applied to many applications where large amounts of data such as unstructured data are processed. Typical processing applications for unstructured data can include speech and image recognition, natural language processing, bioinformatics, customer relationship management, digital signal processing (DSP), graphics processing (GP), network routing, telemetry such as weather data, data warehousing, and so on. Dataflow processors can be programmed using software and can be applied to highly advanced problems in computer science such as deep learning. Deep learning techniques can include an artificial neural network, a convolutional neural network, etc. The success of these techniques is highly dependent on large quantities of data for training and learning. The data-driven nature of these techniques is well suited to implementations based on dataflow processors. The dataflow processor can receive a dataflow graph such as an acyclic dataflow graph, where the dataflow graph can represent a deep learning network. The dataflow graph can be assembled at runtime, where assembly can include input/output, memory input/output, and so on. The assembled dataflow graph can be executed on the dataflow processor.

The dataflow processors can be organized in a variety of configurations. One configuration can include processing element quads with arithmetic units. A dataflow processor can include one or more processing elements (PE). The processing elements can include a processor, a data memory, an instruction memory, communications capabilities, and so on. Multiple PEs can be grouped, where the groups can include pairs, quads, octets, etc. The PEs arranged in arrangements such as quads can be coupled to arithmetic units, where the arithmetic units can be coupled to or included in data processing units (DPU). The DPUs can be shared between and among quads. The DPUs can provide arithmetic techniques to the PEs, communications between quads, and so on.

The dataflow processors, including dataflow processors arranged in quads, can be loaded with kernels. The kernels can be included in a dataflow graph, for example. In order for the dataflow processors to operate correctly, the quads can require reset and configuration modes. Processing elements can be configured into clusters of PEs. Kernels can be loaded onto PEs in the cluster, where the loading of kernels can be based on availability of free PEs, an amount of time to load the kernel, an amount of time to execute the kernel, and so on. Reset can begin with initializing up-counters coupled to PEs in a cluster of PEs. Each up-counter is initialized with a value-1+, the Manhattan distance from a given PE in a cluster to the end of the cluster. A Manhattan distance can include a number of steps to the east, west, north, and south. A control signal can be propagated from the start cluster to the end cluster. The control signal advances 1 cluster per cycle. When the counters for the PEs all reach 0, then the processors have been reset. The processors can be suspended for configuration, where configuration can include loading one or more kernels onto the cluster. The processors can be enabled to execute the one or more kernels. A configuration mode for a cluster can include propagating a signal. Clusters can be preprogrammed to enter configuration mode. Various techniques, including direct memory access (DMA) can be used to load instructions from the kernel into instruction memories of the PEs. The clusters that were pre-programmed into configuration mode can be preprogrammed to exit configuration mode. When configuration mode has been exited, execution of the one or more kernels loaded onto the clusters can commence.

Dataflow processes that can be executed by dataflow processors can be managed by a software stack. A software stack can include a set of subsystems, including software subsystems, which may be needed to create a software platform. The software platform can include a complete software platform. A complete software platform can include a set of software subsystems required to support one or more applications. A software stack can include offline operations and online operations. Offline operations can include software subsystems such as compilers, linker simulators, emulators, and so on. The offline software subsystems can be included in a software development kit (SDK). The online operations can include dataflow partitioning, dataflow graph throughput optimization, and so on. The online operations can be executed on a session host and can control a session manager. Online operations can include resource management, monitors, drivers, etc. The online operations can be executed on an execution engine. The online operations can include a variety of tools which can be stored in an agent library. The tools can include BLAS™, CONV2D™, SoftMax™, and so on.

Software to be executed on a dataflow processor can include precompiled software or agent generation. The pre-compiled agents can be stored in an agent library. An agent library can include one or more computational models which can simulate actions and interactions of autonomous agents. Autonomous agents can include entities such as groups, organizations, and so on. The actions and interactions of the autonomous agents can be simulated to determine how the agents can influence operation of a whole system. Agent source code can be provided from a variety of sources. The agent source code can be provided by a first entity, provided by a second entity, and so on. The source code can be updated by a user, downloaded from the Internet, etc. The agent source code can be processed by a software development kit, where the software development kit can include compilers, linkers, assemblers, simulators, debuggers, and so on. The agent source code that can be operated on by the software development kit (SDK) can be in an agent library. The agent source code can be created using a variety of tools, where the tools can include MATMUL™, Batchnorm™, Relu™, and so on. The agent source code that has been operated on can include functions, algorithms, heuristics, etc., that can be used to implement a deep learning system.

A software development kit can be used to generate code for the dataflow processor or processors. The software development kit (SDK) can include a variety of tools which can be used to support a deep learning technique or other technique which requires processing of large amounts of data such as unstructured data. The SDK can support multiple machine learning techniques such as machine learning techniques based on GAMM™, sigmoid, and so on. The SDK can include a low-level virtual machine (LLVM) which can serve as a front end to the SDK. The SDK can include a simulator. The SDK can include a Boolean satisfiability solver (SAT solver). The SAT solver can include a compiler, a linker, and so on. The SDK can include an architectural simulator, where the architectural simulator can simulate a dataflow processor or processors. The SDK can include an assembler, where the assembler can be used to generate object modules. The object modules can represent agents. The agents can be stored in a library of agents. Other tools can be included in the SDK. The various techniques of the SDK can operate on various representations of a wave flow graph (WFG).

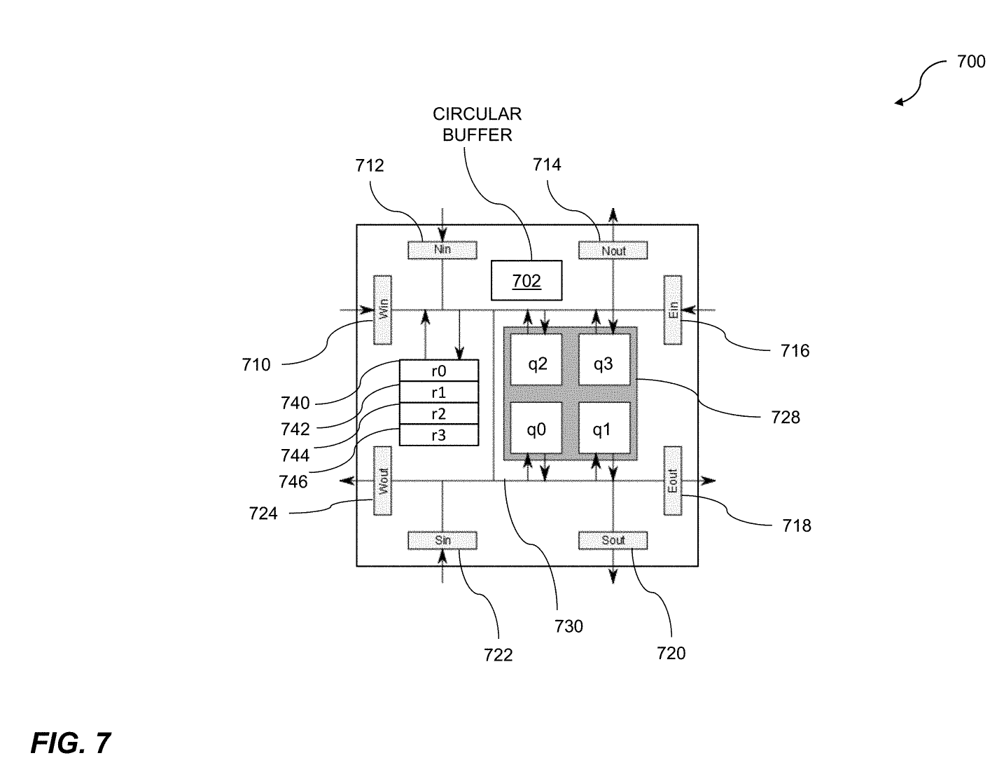

FIG. 7 shows a cluster for coarse-grained reconfigurable processing. The cluster for coarse-grained reconfigurable processing 700 can be used for pipelined tensor manipulation within a reconfigurable fabric. Data can be obtained from a first switching unit, where the first switching unit can be controlled by a first circular buffer. Data can be sent to a second switching element, where the second switching element can be controlled by a second circular buffer. The obtaining data from the first switching element and the sending data to the second switching element can include a direct memory access (DMA). The cluster 700 comprises a circular buffer 702. The circular buffer 702 can be referred to as a main circular buffer or a switch-instruction circular buffer. In some embodiments, the cluster 700 comprises additional circular buffers corresponding to processing elements within the cluster. The additional circular buffers can be referred to as processor instruction circular buffers. The example cluster 700 comprises a plurality of logical elements, configurable connections between the logical elements, and a circular buffer 702 controlling the configurable connections. The logical elements can further comprise one or more of switching elements, processing elements, or storage elements. The example cluster 700 also comprises four processing elements: q0, q1, q2, and q3. The four processing elements can collectively be referred to as a “quad,” and is jointly indicated by a grey reference box 728. In embodiments, there is intercommunication among and between each of the four processing elements. In embodiments, the circular buffer 702 controls the passing of data to the quad of processing elements 728 through switching elements. In embodiments, the four processing elements 728 comprise a processing cluster. In some cases, the processing elements can be placed into a sleep state. In embodiments, the processing elements wake up from a sleep state when valid data is applied to the inputs of the processing elements. In embodiments, the individual processors of a processing cluster share data and/or instruction caches. The individual processors of a processing cluster can implement message transfer via a bus or shared memory interface. Power gating can be applied to one or more processors (e.g. q1) in order to reduce power.

The cluster 700 can further comprise storage elements coupled to the configurable connections. As shown, the cluster 700 comprises four storage elements—r0 740, r1 742, r2 744, and r3 746. The cluster 700 further comprises a north input (Nin) 712, a north output (Nout) 714, an east input (Ein) 716, an east output (Eout) 718, a south input (Sin) 722, a south output (Sout) 720, a west input (Win) 710, and a west output (Wout) 724. The circular buffer 702 can contain switch instructions that implement configurable connections. For example, an instruction effectively connects the west input 710 with the north output 714 and the east output 718 and this routing is accomplished via bus 730. The cluster 700 can further comprise a plurality of circular buffers residing on a semiconductor chip where the plurality of circular buffers controls unique, configurable connections between the logical elements. The storage elements can include instruction random access memory (I-RAM) and data random access memory (D-RAM). The I-RAM and the D-RAM can be quad I-RAM and quad D-RAM, respectively, where the I-RAM and/or the D-RAM supply instructions and/or data, respectively, to the processing quad of a switching element.

A preprocessor or compiler can be configured to prevent data collisions within the circular buffer 702. The prevention of collisions can be accomplished by inserting no-op or sleep instructions into the circular buffer (pipeline). Alternatively, in order to prevent a collision on an output port, intermediate data can be stored in registers for one or more pipeline cycles before being sent out on the output port. In other situations, the preprocessor can change one switching instruction to another switching instruction to avoid a conflict. For example, in some instances the preprocessor can change an instruction placing data on the west output 724 to an instruction placing data on the south output 720, such that the data can be output on both output ports within the same pipeline cycle. In a case where data needs to travel to a cluster that is both south and west of the cluster 700, it can be more efficient to send the data directly to the south output port rather than storing the data in a register first, and then sending the data to the west output on a subsequent pipeline cycle.

An L2 switch interacts with the instruction set. A switch instruction typically has a source and a destination. Data is accepted from the source and sent to the destination. There are several sources (e.g. any of the quads within a cluster, any of the L2 directions (North, East, South, West), a switch register, one of the quad RAMs (data RAM, IRAM, PE/Co Processor Register). As an example, to accept data from any L2 direction, a “valid” bit is used to inform the switch that the data flowing through the fabric is indeed valid. The switch will select the valid data from the set of specified inputs. For this to function properly, only one input can have valid data, and the other inputs must all be marked as invalid. It should be noted that this fan-in operation at the switch inputs operates independently for control and data. There is no requirement for a fan-in mux to select data and control bits from the same input source. Data valid bits are used to select valid data, and control valid bits are used to select the valid control input. There are many sources and destinations for the switching element, which can result in too many instruction combinations, so the L2 switch has a fan-in function enabling input data to arrive from one and only one input source. The valid input sources are specified by the instruction. Switch instructions are therefore formed by combining a number of fan-in operations and sending the result to a number of specified switch outputs.

In the event of a software error, multiple valid bits may arrive at an input. In this case, the hardware implementation can implement any safe function of the two inputs. For example, the fan-in could implement a logical OR of the input data. Any output data is acceptable because the input condition is an error, so long as no damage is done to the silicon. In the event that a bit is set to ‘1’ for both inputs, an output bit should also be set to ‘1’. A switch instruction can accept data from any quad or from any neighbor L2 switch. A switch instruction can also accept data from a register or a microDMA controller. If the input is from a register, the register number is specified. Fan-in may not be supported for many registers as only one register can be read in a given cycle. If the input is from a microDMA controller, a DMA protocol is used for addressing the resource.

For many applications, the reconfigurable fabric can be a DMA slave, which enables a host processor to gain direct access to the instruction and data RAMs (and registers) that are located within the quads in the cluster. DMA transfers are initiated by the host processor on a system bus. Several DMA paths can propagate through the fabric in parallel. The DMA paths generally start or finish at a streaming interface to the processor system bus. DMA paths may be horizontal, vertical, or a combination (as determined by a router). To facilitate high bandwidth DMA transfers, several DMA paths can enter the fabric at different times, providing both spatial and temporal multiplexing of DMA channels. Some DMA transfers can be initiated within the fabric, enabling DMA transfers between the block RAMs without external supervision. It is possible for a cluster “A” to initiate a transfer of data between cluster “B” and cluster “C” without any involvement of the processing elements in clusters “B” and “C”. Furthermore, cluster “A” can initiate a fan-out transfer of data from cluster “B” to clusters “C”, “D”, and so on, where each destination cluster writes a copy of the DMA data to different locations within their Quad RAMs. A DMA mechanism may also be used for programming instructions into the instruction RAMs.

Accesses to RAM in different clusters can travel through the same DMA path, but the transactions must be separately defined. A maximum block size for a single DMA transfer can be 8 KB. Accesses to data RAMs can be performed either when the processors are running, or while the processors are in a low power “sleep” state. Accesses to the instruction RAMs and the PE and Co-Processor Registers may be performed during configuration mode. The quad RAMs may have a single read/write port with a single address decoder, thus allowing access to be shared by the quads and the switches. The static scheduler (i.e. the router) determines when a switch is granted access to the RAMs in the cluster. The paths for DMA transfers are formed by the router by placing special DMA instructions into the switches and determining when the switches can access the data RAMs. A microDMA controller within each L2 switch is used to complete data transfers. DMA controller parameters can be programmed using a simple protocol that forms the “header” of each access.

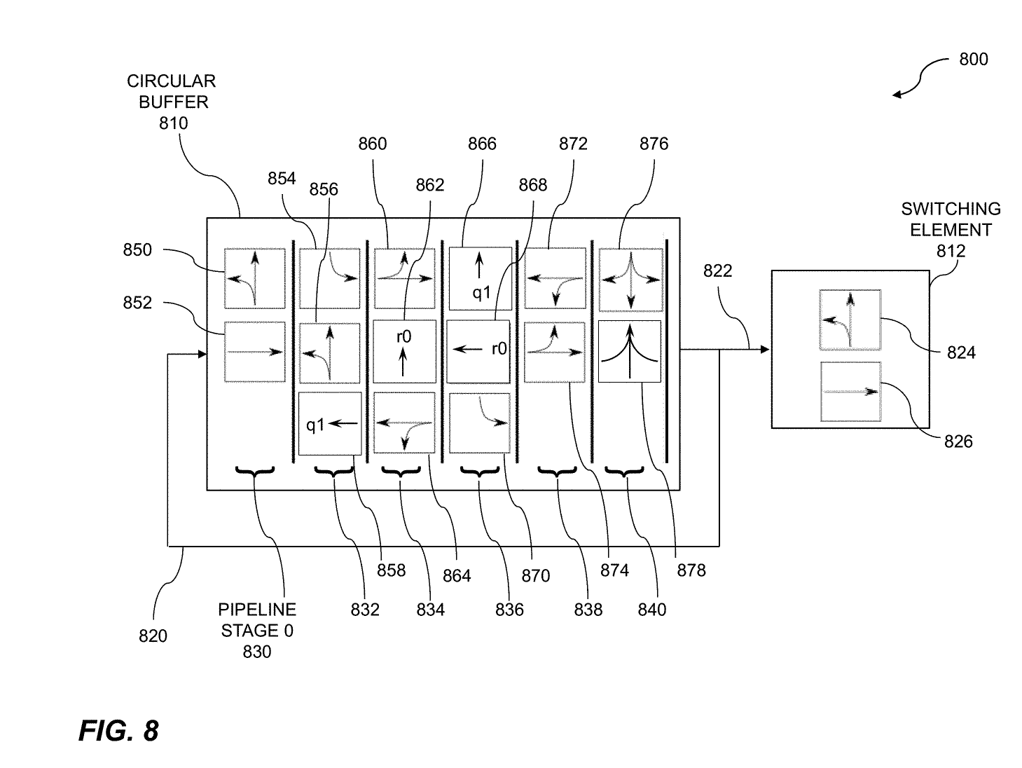

FIG. 8 illustrates a block diagram 800 of a circular buffer. The circular buffer of block diagram 800 can include a switching element 812 corresponding to the circular buffer 810. The circular buffer and the corresponding switching element can be used in part for pipelined tensor manipulation within a reconfigurable fabric. Data can be obtained from a first switching unit, where the first switching unit can be controlled by a first circular buffer. Data can be sent to a second switching element, where the second switching element can be controlled by a second circular buffer. The obtaining data from the first switching element and the sending data to the second switching element can include a direct memory access (DMA). The block diagram 800 describes a processor-implemented method for data manipulation. The circular buffer 810 contains a plurality of pipeline stages. Each pipeline stage contains one or more instructions, up to a maximum instruction depth. In the embodiment shown in FIG. 8, the circular buffer 810 is a 6×3 circular buffer, meaning that it implements a six-stage pipeline with an instruction depth of up to three instructions per stage (column). Hence, the circular buffer 810 can include one, two, or three switch instruction entries per column. In some embodiments, the plurality of switch instructions per cycle can comprise two or three switch instructions per cycle. However, in certain embodiments, the circular buffer 810 supports only a single switch instruction in a given cycle. In the example block diagram 800 shown, pipeline stage 0 830 has an instruction depth of two instructions 850 and 852. Though the remaining pipeline stages 1-5 are not textually labeled in the example block diagram 800, the stages are indicated by callouts 832, 834, 836, 838, and 840. Pipeline stage 1 832 has an instruction depth of three instructions 854, 856, and 858. Pipeline stage 2 834 has an instruction depth of three instructions 860, 862, and 864. Pipeline stage 3 836 also has an instruction depth of three instructions 866, 868, and 870. Pipeline stage 4 838 has an instruction depth of two instructions 872 and 874. Pipeline stage 5 840 has an instruction depth of two instructions 876 and 878. In embodiments, the circular buffer 810 includes 64 columns. During operation, the circular buffer 810 rotates through configuration instructions. The circular buffer 810 can dynamically change operation of the logical elements based on the rotation of the circular buffer. The circular buffer 810 can comprise a plurality of switch instructions per cycle for the configurable connections.

The instruction 852 is an example of a switch instruction. In embodiments, each cluster has four inputs and four outputs, each designated within the cluster's nomenclature as “north,” “east,” “south,” and “west” respectively. For example, the instruction 852 in the diagram 800 is a west-to-east transfer instruction. The instruction 852 directs the cluster to take data on its west input and send out the data on its east output. In another example of data routing, the instruction 850 is a fan-out instruction. The instruction 850 instructs the cluster to take data from its south input and send out on the data through both its north output and its west output. The arrows within each instruction box indicate the source and destination of the data. The instruction 878 is an example of a fan-in instruction. The instruction 878 takes data from the west, south, and east inputs and sends out the data on the north output. Therefore, the configurable connections can be considered to be time multiplexed.

In embodiments, the clusters implement multiple storage elements in the form of registers. In the example block diagram 800 shown, the instruction 862 is a local storage instruction. The instruction 862 takes data from the instruction's south input and stores it in a register (r0). Another instruction (not shown) is a retrieval instruction. The retrieval instruction takes data from a register (e.g. r0) and outputs it from the instruction's output (north, south, east, west). Some embodiments utilize four general purpose registers, referred to as registers r0, r1, r2, and r3. The registers are, in embodiments, storage elements which store data while the configurable connections are busy with other data. In embodiments, the storage elements are 32-bit registers. In other embodiments, the storage elements are 64-bit registers. Other register widths are possible.

The obtaining data from a first switching element and the sending the data to a second switching element can include a direct memory access (DMA). A DMA transfer can continue while valid data is available for the transfer. A DMA transfer can terminate when it has completed without error, or when an error occurs during operation. Typically, a cluster that initiates a DMA transfer will request to be brought out of sleep state when the transfer is completed. This waking is achieved by setting control signals that can control the one or more switching elements. Once the DMA transfer is initiated with a start instruction, a processing element or switching element in the cluster can execute a sleep instruction to place itself to sleep. When the DMA transfer terminates, the processing elements and/or switching elements in the cluster can be brought out of sleep after the final instruction is executed. Note that if a control bit can be set in the register of the cluster that is operating as a slave in the transfer, that cluster can also be brought out of sleep state if it is asleep during the transfer.

The cluster that is involved in a DMA and can be brought out of sleep after the DMA terminates can determine that it has been brought out of a sleep state based on the code that is executed. A cluster can be brought out of a sleep state based on the arrival of a reset signal and the execution of a reset instruction. The cluster can be brought out of sleep by the arrival of valid data (or control) following the execution of a switch instruction. A processing element or switching element can determine why it was brought out of a sleep state by the context of the code that the element starts to execute. A cluster can be awoken during a DMA operation by the arrival of valid data. The DMA instruction can be executed while the cluster remains asleep as the cluster awaits the arrival of valid data. Upon arrival of the valid data, the cluster is woken and the data stored. Accesses to one or more data random access memories (RAM) can be performed when the processing elements and the switching elements are operating. The accesses to the data RAMs can also be performed while the processing elements and/or switching elements are in a low power sleep state.

In embodiments, the clusters implement multiple processing elements in the form of processor cores, referred to as cores q0, q1, q2, and q3. In embodiments, four cores are used, though any number of cores can be implemented. The instruction 858 is a processing instruction. The instruction 858 takes data from the instruction's east input and sends it to a processor q1 for processing. The processors can perform logic operations on the data, including, but not limited to, a shift operation, a logical AND operation, a logical OR operation, a logical NOR operation, a logical XOR operation, an addition, a subtraction, a multiplication, and a division. Thus, the configurable connections can comprise one or more of a fan-in, a fan-out, and a local storage.

In the example 800 shown, the circular buffer 810 rotates instructions in each pipeline stage into switching element 812 via a forward data path 822, and also back to a pipeline stage 0 830 via a feedback data path 820. Instructions can include switching instructions, storage instructions, and processing instructions, among others. The feedback data path 820 can allow instructions within the switching element 812 to be transferred back to the circular buffer. Hence, the instructions 824 and 826 in the switching element 812 can also be transferred back to pipeline stage 0 as the instructions 850 and 852. In addition to the instructions depicted on FIG. 8, a no-op instruction can also be inserted into a pipeline stage. In embodiments, a no-op instruction causes execution to not be performed for a given cycle. In effect, the introduction of a no-op instruction can cause a column within the circular buffer 810 to be skipped in a cycle. In contrast, not skipping an operation indicates that a valid instruction is being pointed to in the circular buffer. A sleep state can be accomplished by not applying a clock to a circuit, performing no processing within a processor, removing a power supply voltage or bringing a power supply to ground, storing information into a non-volatile memory for future use and then removing power applied to the memory, or by similar techniques. A sleep instruction that causes no execution to be performed until a predetermined event occurs which causes the logical element to exit the sleep state can also be explicitly specified. The predetermined event can be the arrival or availability of valid data. The data can be determined to be valid using null convention logic (NCL). In embodiments, only valid data can flow through the switching elements and invalid data points (Xs) are not propagated by instructions.

In some embodiments, the sleep state is exited based on an instruction applied to a switching fabric. The sleep state can, in some embodiments, only be exited by a stimulus external to the logical element and not based on the programming of the logical element. The external stimulus can include an input signal, which in turn can cause a wake up or an interrupt service request to execute on one or more of the logical elements. An example of such a wake-up request can be seen in the instruction 858, assuming that the processor q1 was previously in a sleep state. In embodiments, when the instruction 858 takes valid data from the east input and applies that data to the processor q1, the processor q1 wakes up and operates on the received data. In the event that the data is not valid, the processor q1 can remain in a sleep state. At a later time, data can be retrieved from the q1 processor, e.g. by using an instruction such as the instruction 866. In the case of the instruction 866, data from the processor q1 is moved to the north output. In some embodiments, if Xs have been placed into the processor q1, such as during the instruction 858, then Xs would be retrieved from the processor q1 during the execution of the instruction 866 and applied to the north output of the instruction 866.

A collision occurs if multiple instructions route data to a particular port in a given pipeline stage. For example, if instructions 852 and 854 are in the same pipeline stage, they will both send data to the east output at the same time, thus causing a collision since neither instruction is part of a time-multiplexed fan-in instruction (such as the instruction 878). To avoid potential collisions, certain embodiments use preprocessing, such as by a compiler, to arrange the instructions in such a way that there are no collisions when the instructions are loaded into the circular buffer. Thus, the circular buffer 810 can be statically scheduled in order to prevent data collisions. Thus, in embodiments, the circular buffers are statically scheduled. In embodiments, when the preprocessor detects a data collision, the scheduler changes the order of the instructions to prevent the collision. Alternatively, or additionally, the preprocessor can insert further instructions such as storage instructions (e.g. the instruction 862), sleep instructions, or no-op instructions, to prevent the collision. Alternatively, or additionally, the preprocessor can replace multiple instructions with a single fan-in instruction. For example, if a first instruction sends data from the south input to the north output and a second instruction sends data from the west input to the north output in the same pipeline stage, the first and second instruction can be replaced with a fan-in instruction that routes the data from both of those inputs to the north output in a deterministic way to avoid a data collision. In this case, the machine can guarantee that valid data is only applied on one of the inputs for the fan-in instruction.

Returning to DMA, a channel configured as a DMA channel requires a flow control mechanism that is different from regular data channels. A DMA controller can be included in interfaces to master DMA transfer through the processing elements and switching elements. For example, if a read request is made to a channel configured as DMA, the Read transfer is mastered by the DMA controller in the interface. It includes a credit count that keeps track of the number of records in a transmit (Tx) FIFO that are known to be available. The credit count is initialized based on the size of the Tx FIFO. When a data record is removed from the Tx FIFO, the credit count is increased. If the credit count is positive, and the DMA transfer is not complete, an empty data record can be inserted into a receive (Rx) FIFO. The memory bit is set to indicate that the data record should be populated with data by the source cluster. If the credit count is zero (meaning the Tx FIFO is full), no records are entered into the Rx FIFO. The FIFO to fabric block will make sure the memory bit is reset to 0 and thereby prevents a microDMA controller in the source cluster from sending more data.

Each slave interface manages four interfaces between the FIFOs and the fabric. Each interface can contain up to 15 data channels. Therefore, a slave should manage read/write queues for up to 60 channels. Each channel can be programmed to be a DMA channel, or a streaming data channel. DMA channels are managed using a DMA protocol. Streaming data channels are expected to maintain their own form of flow control using the status of the Rx FIFOs (obtained using a query mechanism). Read requests to slave interfaces use one of the flow control mechanisms described previously.

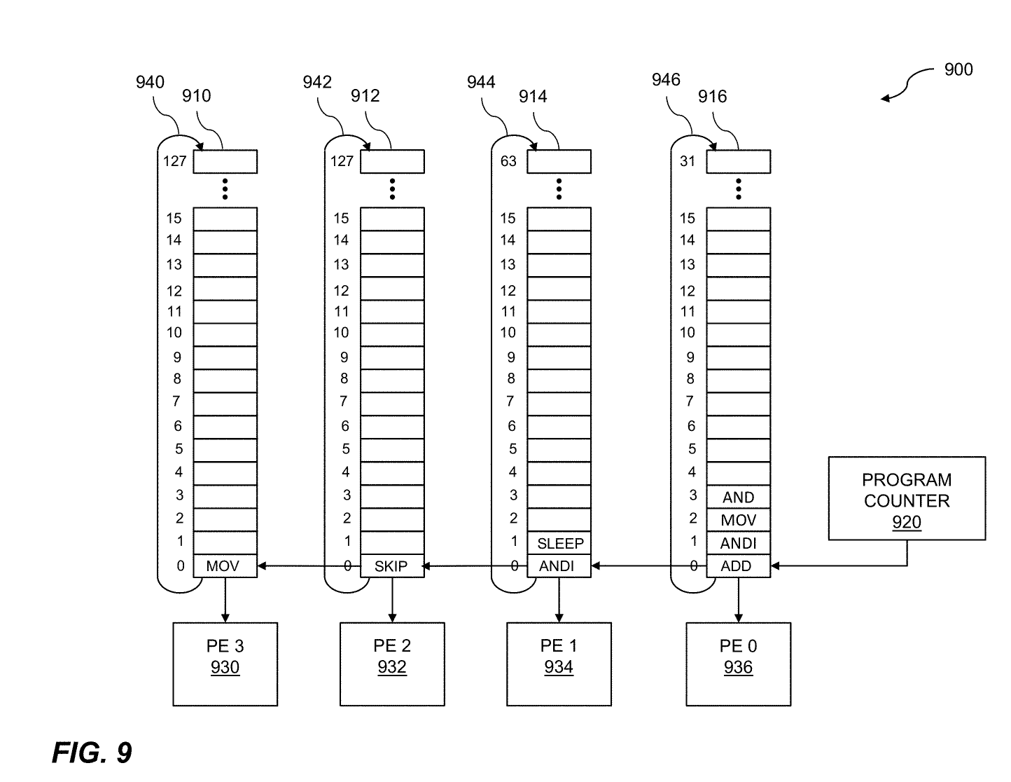

FIG. 9 illustrates a circular buffer and processing elements. The figure shows a diagram 900 indicating example instruction execution for processing elements. The instruction execution can include instructions for tensor radix point calculation in a neural network. A circular buffer 910 feeds a processing element 930. A second circular buffer 912 feeds another processing element 932. A third circular buffer 914 feeds another processing element 934. A fourth circular buffer 916 feeds another processing element 936. These circular buffers are shown with lengths of 128, 64, and 32 entries, but various lengths are possible. The four processing elements 930, 932, 934, and 936 can represent a quad of processing elements. In embodiments, the processing elements 930, 932, 934, and 936 are controlled by instructions received from the circular buffers 910, 912, 914, and 916. The circular buffers can be implemented using feedback paths 940, 942, 944, and 946, respectively. In embodiments, the circular buffer can control the passing of data to a quad of processing elements through switching elements, where each of the quad of processing elements is controlled by four other circular buffers (as shown in the circular buffers 910, 912, 914, and 916) and where data is passed back through the switching elements from the quad of processing elements where the switching elements are again controlled by the main circular buffer. In embodiments, a program counter 920 is configured to point to the current instruction within a circular buffer. In embodiments with a configured program counter, the contents of the circular buffer are not shifted or copied to new locations on each instruction cycle. Rather, the program counter 920 is incremented in each cycle to point to a new location in the circular buffer. The circular buffers 910, 912, 914, and 916 can contain instructions for the processing elements. The instructions can include, but are not limited to, move instructions, skip instructions, logical AND instructions, logical AND-Invert (e.g. ANDI) instructions, logical OR instructions, mathematical ADD instructions, shift instructions, sleep instructions, and so on. A sleep instruction can be usefully employed in numerous situations. The sleep state can be entered by an instruction within one of the processing elements. One or more of the processing elements can be in a sleep state at any given time. In some embodiments, a “skip” can be performed on an instruction and the instruction in the circular buffer can be ignored and the corresponding operation not performed.

The plurality of circular buffers can have differing lengths. That is, the plurality of circular buffers can comprise circular buffers of differing sizes. In embodiments, the circular buffers 910 and 912 have a length of 128 instructions, the circular buffer 914 has a length of 64 instructions, and the circular buffer 916 has a length of 32 instructions, but other circular buffer lengths are also possible. In some embodiments, all buffers have the same length. The plurality of circular buffers that have differing lengths can resynchronize with a zeroth pipeline stage for each of the plurality of circular buffers. The circular buffers of differing sizes can restart at a same time step. In other embodiments, the plurality of circular buffers includes a first circular buffer repeating at one frequency and a second circular buffer repeating at a second frequency. In this situation, the first circular buffer is of one length. When the first circular buffer finishes through a loop, it can restart operation at the beginning, even though the second, longer circular buffer has not yet completed its operations. When the second circular buffer reaches completion of its loop of operations, the second circular buffer can restart operations from its beginning.

As can be seen in FIG. 9, different circular buffers can have different instruction sets within them. For example, the first circular buffer 910 contains a MOV instruction. The second circular buffer 912 contains a SKIP instruction. The third circular buffer 914 contains a SLEEP instruction and an ANDI instruction. The fourth circular buffer 916 contains an AND instruction, a MOVE instruction, an ANDI instruction, and an ADD instruction. The operations performed by the processing elements 930, 932, 934, and 936 are dynamic and can change over time, based on the instructions loaded into the respective circular buffers. As the circular buffers rotate, new instructions can be executed by the respective processing element.

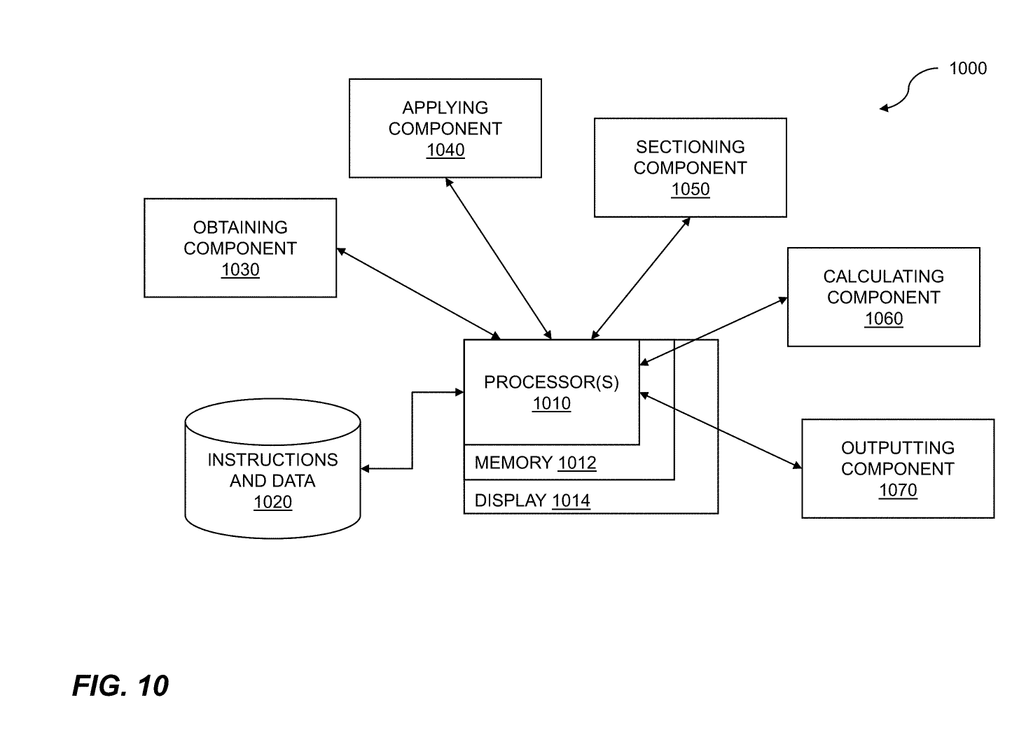

FIG. 10 is a system diagram for pipelined tensor manipulation within a reconfigurable fabric. The system 1000 can include one or more processors 1010 coupled to a memory 1012 which stores instructions. The system 1000 can include a display 1014 coupled to the one or more processors 1010 for displaying data, intermediate steps, instructions, and so on. In embodiments, one or more processors 1010 are attached to the memory 1012 where the one or more processors, when executing the instructions which are stored, are configured to: obtain a tensor for processing on a reconfigurable fabric comprised of a plurality of processing elements; apply the tensor as input to a pipeline of agents running on the plurality of processing elements; section the tensor into one or more subsections; apply a first subsection from the one or more subsections to a first agent in the pipeline of agents; calculate a first result by the first agent for the first subsection; and output the first result to a second agent in the pipeline of agents.

The system 1000 can include a collection of instructions and data 1020. The instructions and data 1020 may be stored in a database, one or more statically linked libraries, one or more dynamically linked libraries, precompiled headers, source code, flow graphs, kernels, or other suitable formats. The instructions can include instructions for pipelined tensor manipulation within a reconfigurable fabric. The instructions can include metadata that is determined for each tensor. The instructions can include a static schedule for controlling a rotating circular buffer, where the rotating circular buffer can be used to control a storage element interposed between the first agent and the second agent.

The system 1000 can include an obtaining component 1030. The obtaining component 1030 can include functions and instructions for obtaining a tensor for processing on a reconfigurable fabric comprised of a plurality of processing elements. The first input tensor can include fixed-point numerical representations and can include tensor metadata. The system 1000 can include an applying component 1040. The applying component 1040 can include functions and instructions for applying the tensor as input to a pipeline of agents running on the plurality of processing elements. The tensor can be applied in its entirety. The system 1000 can include a sectioning component 1050. The sectioning component 1050 can include functions and instructions for sectioning the tensor into one or more subsections. In embodiments, the first subsection being applied to the first agent can be the tensor in its entirety. The tensor can be sectioned based on blocks, rows, etc. In embodiments, the first subsection being applied to the first agent can include a block from the tensor, while in other embodiments, the first subsection being applied to the first agent can include a row from the tensor. The tensor can be sectioned based on columns. In embodiments, the first subsection being applied to the first agent can include a column from the tensor.

The system 1000 can include a calculating component 1060. The calculating component 1060 can include functions and instructions for calculating a first result by the first agent for the first subsection. The result calculated by the first agent can include a tensor operation such as a tensor product, a tensor contraction, raising or lowering an index of a tensor, and so on. The system 1000 can include an outputting component 1070. The outputting component 1070 can include functions and instructions for outputting the first result to a second agent in the pipeline of agents. The second agent can calculate a second result based on the first result. The second agent can output the second result to a third agent in the pipeline of agents, and so on. The outputting can include writing to storage interposed between the first agent and the second agent, writing to a storage element coupled to the reconfigurable fabric, and so on.

The system 1000 can include a computer program product embodied in a non-transitory computer readable medium for computational manipulation, the computer program product comprising code which causes one or more processors to perform operations of: obtaining a tensor for processing on a reconfigurable fabric comprised of a plurality of processing elements; applying the tensor as input to a pipeline of agents running on the plurality of processing elements; sectioning the tensor into one or more subsections; applying a first subsection from the one or more subsections to a first agent in the pipeline of agents; calculating a first result by the first agent for the first subsection; and outputting the first result to a second agent in the pipeline of agents.

Each of the above methods may be executed on one or more processors on one or more computer systems. Embodiments may include various forms of distributed computing, client/server computing, and cloud based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and descriptions set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”— may be implemented by computer program instructions, by special-purpose hardware-based computer systems, by combinations of special purpose hardware and computer instructions, by combinations of general purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are neither limited to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for tensor manipulation comprising:
obtaining a tensor for processing on a reconfigurable fabric comprised of a plurality of processing elements;
applying the tensor as input to a pipeline of agents running on the plurality of processing elements;
sectioning the tensor into one or more subsections;
applying a first subsection from the one or more subsections to a first agent in the pipeline of agents;
calculating a first result by the first agent for the first subsection; and
outputting the first result to a second agent in the pipeline of agents.

2. The method of claim 1 further comprising calculating a second result, by the second agent, based on the first result.

3. The method of claim 2 further comprising outputting the second result to a third agent in the pipeline of agents.

4. The method of claim 3 wherein the second result comprises a tensor block.

5-7. (canceled)

8. The method of claim 2 further comprising sending, by the second agent, a subsection done indication, to the first agent, when the calculating the second result is accomplished.

9. The method of claim 2 further comprising applying a second subsection from the one or more subsections to the first agent in the pipeline of agents.

10. The method of claim 9 further comprising calculating a third result, by the first agent, for the second subsection from the one or more subsections.

11. The method of claim 10 further comprising outputting the third result, by the first agent, to the second agent.

12. The method of claim 10 wherein the calculating the third result, by the first agent, is performed contemporaneously with the calculating the second result, by the second agent.

13. The method of claim 1 further comprising storing the first result in a storage element interposed between the first agent and the second agent.

14. The method of claim 13 wherein the storage element comprises FIFO storage.

15. The method of claim 13 wherein the storage element is controlled by a rotating circular buffer.

16. (canceled)

17. The method of claim 13 further comprising sending a fire indication, by the first agent, to the second agent, signifying the first result has been written to the storage element.

18-20. (canceled)

21. The method of claim 13 further comprising sending a done indication, by the second agent, to the first agent, signifying the first result has been read from the storage element.

22-24. (canceled)

25. The method of claim 1 further comprising storing the first result in a storage element coupled to the reconfigurable fabric.

26. The method of claim 25 wherein the storing comprises direct memory access (DMA).

27. The method of claim 1 wherein the first subsection being applied to the first agent is the tensor in its entirety.

28. The method of claim 1 wherein the first subsection being applied to the first agent comprises a block from the tensor.

29. The method of claim 1 wherein the first subsection being applied to the first agent comprises a row from the tensor.

30. The method of claim 1 wherein the first subsection being applied to the first agent comprises a column from the tensor.

31. A computer program product embodied in a non-transitory computer readable medium for computational manipulation, the computer program product comprising code which causes one or more processors to perform operations of:
obtaining a tensor for processing on a reconfigurable fabric comprised of a plurality of processing elements;
applying the tensor as input to a pipeline of agents running on the plurality of processing elements;
sectioning the tensor into one or more subsections;
applying a first subsection from the one or more subsections to a first agent in the pipeline of agents;
calculating a first result by the first agent for the first subsection; and
outputting the first result to a second agent in the pipeline of agents.

32. (canceled)

33. A pipelined tensor processing system comprising:
a first processor element; and
a second processor element coupled reconfigurably to the first processor element to provide a reconfigurable pipeline fabric for tensor processing, wherein a tensor accessed by the fabric is partitionable into one or more subsections for pipelined processing by the first and second processor elements.
